(19) United States
(12) Patent Application Publication
(10) Pub. No.: US 2004/0146776 A1
(43) Pub. Date: Jul. 29, 2004

(54) Zinc fuel cell

(76) Inventor: Jen-Fu Chen, Feng Yuan City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/351,835

(22) Filed: Jan. 27, 2003

(51) Int. Cl. H01M 2/38; H01M 12/06; H01M 6/32

(52) U.S. Cl. 429/63; 429/27; 429/80; 429/118

(57) ABSTRACT

A fuel cell includes a reaction chamber, at least one fuel chip stored in the reaction chamber, an electrolyte chamber communicated with the reaction chamber, electrolyte installed in the electrolyte chamber. The control element is movable between a first position and a second position. In the first position, the control element avoids the electrolyte flowing from the electrolyte chamber into the reaction chamber. In the second position, the control element allows the electrolyte to flow from the electrolyte chamber into the reaction chamber for reacting with the fuel chips for generating electricity. Alternatively, a pump is used to for pumping vapor into the reaction chamber for reacting with the fuel chips for generating electricity.

### BACKGROUND OF INVENTION

1. Field of Invention

The present invention relates to a zinc fuel cell.

2. Related Prior Art

Taiwanese Patent Publication No. 499052 discloses a zinc-air fuel cell including an anode 10 in the form of a container and a plurality of fuel particles contained in the container 10. Electrolyte 21 is contained in the container 10. Each of the fuel particles includes a ball 20 made of zinc, electrolyte 21 and fuel made of zinc. The ball 20 defines a central space for storing the electrolyte 21 and the fuel and an aperture 22 through which the electrolyte 21 can flow from the central space of the ball 20. The fuel is configured as a plurality of semi-spheres 23, as spokes 24 or as a beehive 25 for separating the central space of the ball 20 into a plurality of sub-spaces each for containing a portion of the electrode 21. Only after a portion of the fuel is consumed because of its reaction with the electrolyte 21 contained in the container 10, the electrolyte 2I contained in the sub-spaces defined by this portion of the fuel is released for reaction with another portion of the fuel. However, the production of the fuel particles is complicated and expensive. The process for releasing the electrolyte 21 at a predetermined rate is complicated, too.

The present invention is therefore intended to obviate or at least alleviate the problems encountered in prior art.

### SUMMARY OF INVENTION

It is the primary objective of the present invention to provide a simple and therefore non-expensive fuel cell.

According to the present invention, a fuel cell includes a reaction chamber, at least one fuel chip stored in the reaction chamber, an electrolyte chamber communicated with the reaction chamber, electrolyte installed in the electrolyte chamber. The control element is movable between a first position and a second position. In the first position, the control element avoids the electrolyte flowing from the electrolyte chamber into the reaction chamber. In the second position, the control element allows the electrolyte to flow from the electrolyte chamber into the reaction chamber for reacting with the fuel chips for generating electricity. Alternatively, a pump is used to for pumping vapor into the reaction chamber for reacting with the fuel chips for generating electricity.

Other objects, advantages, and novel features of this invention will become more apparent from the following detailed description in conjunction with the drawings.

### BRIEF DESCRIPTION OF DRAWINGS

The present invention will be described through detailed illustration of embodiments referring to the attached drawings wherein:

FIGS. 1-5 are cross-sectional views of a zinc fuel cell in different steps of a process for providing power according to the preferred embodiment of the present invention.

### DETAILED DESCRIPTION OF PREFERRED EMBODIMENT

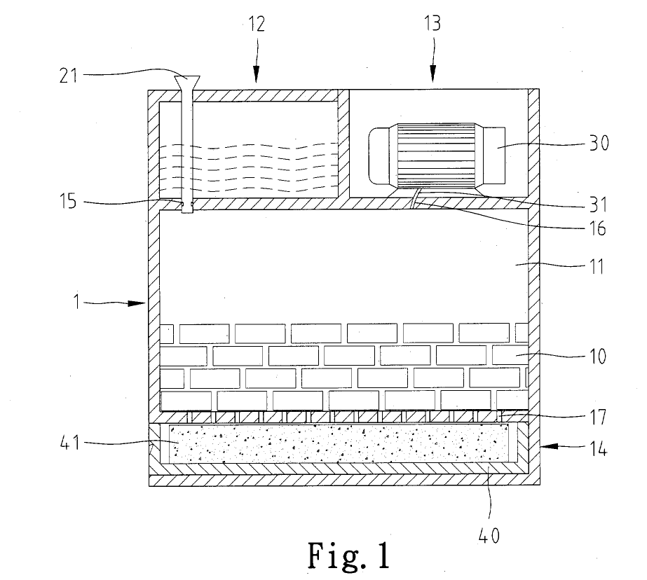

Referring to FIG. 1, according to the preferred embodiment of the present invention, a fuel cell 1 includes a first chamber 11, a second chamber 12, a third chamber 13 and a fourth chamber 14. The fuel cell 1 includes a plurality of fuel chips 10 stored in the first chamber 11. The fuel chips 10 are made of zinc. Appropriate electrolyte or vapor can be introduced into the first chamber 11 so as to react with the fuel chips 10 for generation of electricity. The first chamber 11 is communicated with the second chamber 12 through an aperture 15, with the third chamber 13 through an aperture 16, and with the second chamber 12 through a plurality of apertures 17.

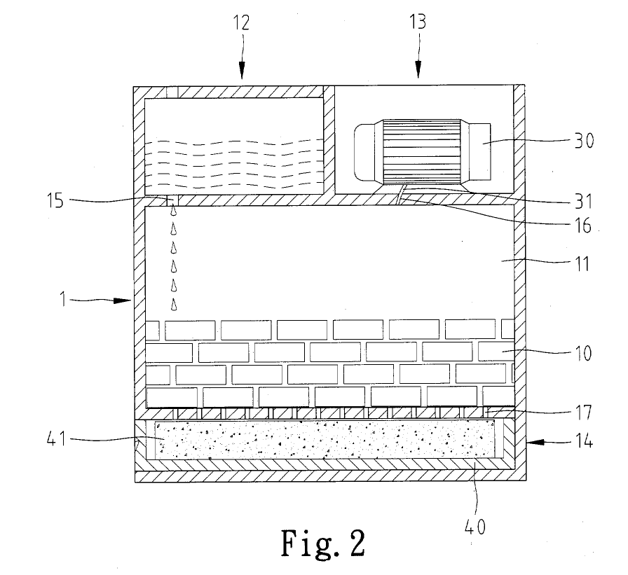

The electrolyte is contained in the second chamber 12. In an idle position of the fuel cell 1 shown in FIG. 1, a plug 21 is fit in the aperture 21 in order to avoid the electrolyte flowing into the first chamber 11 from the second chamber 12. In a working position of the fuel cell 1 as shown in FIG. 2, the plug 21 is removed from the aperture 15, thus allowing the electrolyte to flow into the first chamber 11 from the second chamber 12. The electrolyte reacts with the fuel chips 10 in the first chamber 11.

A pump 30 is installed in the third chamber 13. A pipe 31 leads from the pump 30 into the first chamber 11 through the aperture 16. Vapor can be pumped into the first chamber 11 through the pipe 31 by means of the pump 30.

A waste collector 40 is slid into the fourth chamber 14 for collecting waste resulting from the reaction occurring in the first chamber 11. In the preferred embodiment, the waste collector 40 is configured as a drawer in which a sponge 41 is installed in order to absorb such waste.

Referring to FIG. 2, the plug 21 is removed from the aperture 15, because of the gravity, the electrolyte flows into the first chamber 11 from the second chamber 12. In the first chamber 11, the electrolyte reacts with the fuel chips 10. Thus, electricity is generated.

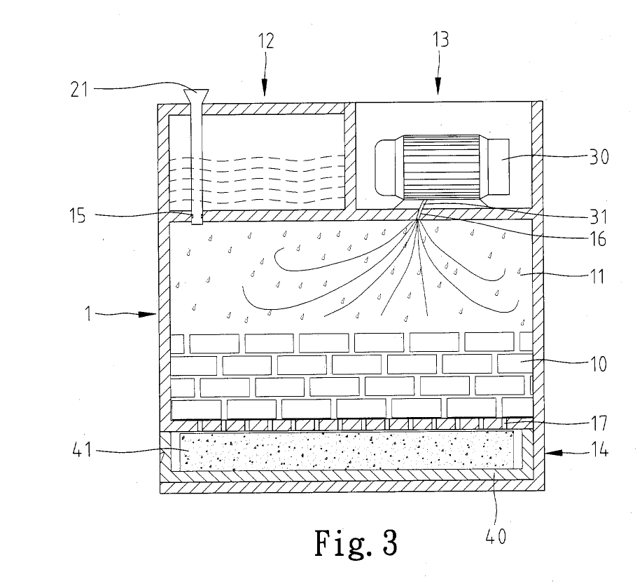

Referring to FIG. 3, the plug 21 is fit in the aperture 15 so as to avoid the electrolyte flowing into the first chamber 11 from the second chamber 12. Instead, the vapor is pumped into the first chamber 11 through the pipe 31 by means of the pump 30. In the first chamber 11, the vapor reacts with the fuel chips 10 for generating electricity.

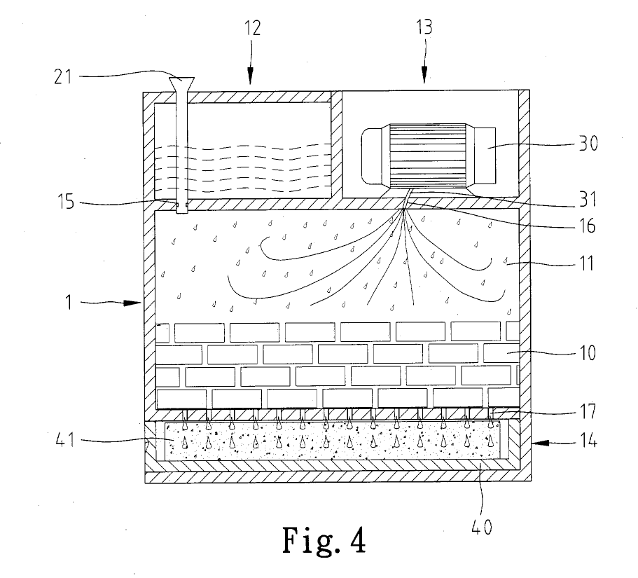

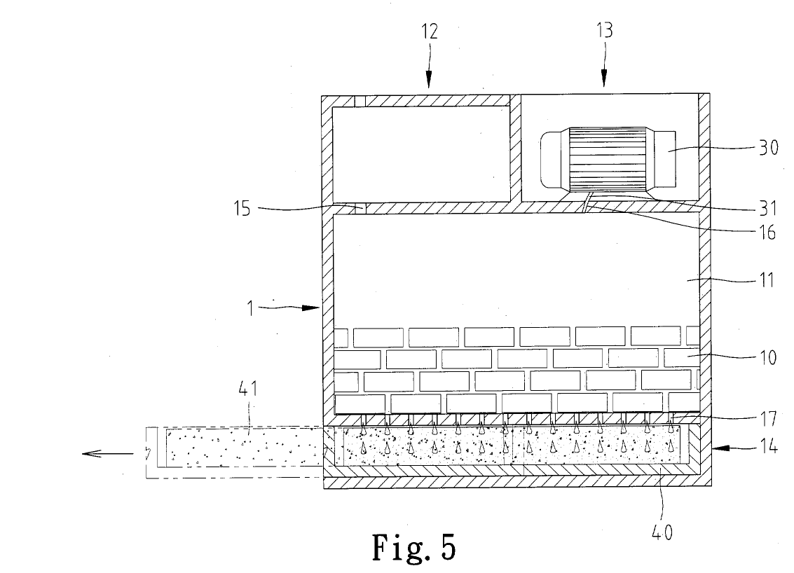

Referring to FIG. 4, the electrolyte or the vapor reacts with the fuel chips 10 and results in waste in the form of liquid. The waste flows from the first chamber 11 into the fourth chamber 14 through the apertures 17. In the fourth chamber 14, the waste is absorbed by means of the sponge 41. Referring to FIG. 5, when the sponge 41 is saturated of the waste, the drawer 40 is pulled from the fourth chamber 14 so that the used sponge 41 can be cleaned or replaced with another clean sponge 41.

This invention has been described through illustration of the preferred embodiment. Those skilled in the art can derive variations from the preferred embodiment without departing from the scope of the present invention. Hence, the preferred embodiment shall not limit the scope of the present invention defined in the claims.

What is claimed is:

1. A fuel cell including:
a reaction chamber;
at least one fuel chip stored in the reaction chamber;
an electrolyte chamber communicated with the reaction chamber;
electrolyte contained in the electrolyte chamber; and
a control element movable between a first position for avoiding the electrolyte flowing from the electrolyte chamber into the reaction chamber and a second position for allowing the electrolyte to flow from the electrolyte chamber into the reaction chamber for reacting with the fuel chips for generating electricity.

2. The fuel cell according to claim 1 wherein the at least one fuel chip is made of zinc.

3. The fuel cell according to claim 1 wherein the control element is a plug for sealing an aperture through the reaction chamber is communicated with the electrolyte chamber.

4. The fuel cell according to claim 1 including a waste chamber communicated with the reaction chamber for receiving waste resulting from the reaction of the fuel chips with the electrolyte.

5. The fuel cell according to claim 4 including a waste collector installed in the waste chamber for collecting the waste.

6. The fuel cell according to claim 5 wherein the waste collector includes a drawer that can be slid into and from the waste chamber.

7. The fuel cell according to claim 6 wherein the waste collector includes a sponge received in the drawer for collecting the waste.

8. A fuel cell including:
a reaction chamber;
at least one fuel chip stored in the reaction chamber; and
a pump for pumping vapor into the reaction chamber for reacting with the fuel chips for generating electricity.

9. The fuel cell according to claim 8 wherein the at least one fuel chip is made of zinc.

10. The fuel cell according to claim 8 including a waste chamber communicated with the reaction chamber for receiving waste resulting from the reaction of the fuel chips with the electrolyte.

11. The fuel cell according to claim 10 including a waste collector installed in the waste chamber for collecting the waste.

12. The fuel cell according to claim 11 wherein the waste collector includes a drawer that can be slid into and from the waste chamber.

13. The fuel cell according to claim wherein the waste collector includes a sponge received in the drawer for collecting the waste.

14. A fuel cell including:
a reaction chamber;
at least one fuel chip stored in the reaction chamber;
an electrolyte chamber communicated with the reaction chamber;
electrolyte contained in the electrolyte chamber;
a control element movable between a first position for avoiding the electrolyte flowing from the electrolyte chamber into the reaction chamber and a second position for allowing the electrolyte to flow from the electrolyte chamber into the reaction chamber for reacting with the fuel chips for generating electricity; and
a pump for pumping vapor into the reaction chamber for reacting with the fuel chips for generating electricity.

15. The fuel cell according to claim 14 wherein the at least one fuel chip is made of zinc.

16. The fuel cell according to claim 14 wherein the control element is a plug for sealing an aperture through the reaction chamber is communicated with the electrolyte chamber.

17. The fuel cell according to claim 16 including a waste chamber communicated with the reaction chamber for receiving waste resulting from the reaction of the fuel chips with the electrolyte.

18. The fuel cell according to claim 17 including a waste collector installed in the waste chamber for collecting the waste.

19. The fuel cell according to claim 18 wherein the waste collector includes a drawer that can be slid into and from the waste chamber.

20. The fuel cell according to claim 19 wherein the waste collector includes a sponge received in the drawer for collecting the waste.
